(19) United States
(12) Patent Application Publication
(10) Pub. No.: US 2009/0076975 A1
(43) Pub. Date: Mar. 19, 2009

(54) STOCK INDEX LIQUIDITY SCREEN

(76) Inventors: Xin Yan, Bellevue, WA (US); Kelly L. Haughton, Gig Harbor, WA (US); Pradeep V. Velvadapu, Seattle, WA (US); Barry E. Feldman, Olalla, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 11/856,669

(22) Filed: Sep. 17, 2007

(51) Int. Cl. G06Q 40/00

(52) U.S. Cl. 705/36 R

(57) ABSTRACT

A method of identifying global securities considered adequately liquid for foreign investment and/or inclusion in a global index. For each security, the method selects a portion of its issues (e.g., local issues) and calculates an Average Daily Trading Volume (“ADTV”) for each issue. The issue having the largest ADTV is identified as the primary issue. The method calculates the Active Trading Ratio (“ATR”) of the primary issue and determines the security is adequately liquid if the ADTV of the primary issue is greater than or equal to a minimum ADTV threshold and the ATR of the primary issue is greater than or equal to a minimum ATR threshold. The method may determine an inadequately liquid security is adequately liquid if the ADTV and ATR of another issue (e.g., a foreign issue) or depository receipts are greater than or equal to the minimum ADTV and ATR thresholds, respectively.

### BACKGROUND OF THE INVENTION

1. Field of the Invention

The present invention is directed to methods of determining a minimum level of liquidity qualifying a security for foreign investment and inclusion in a stock index and to methods of evaluating a security using the minimum level of liquidity.

2. Description of the Related Art

Stock market indexes are intended to represent an entire stock market or a portion of it and thus track changes in the market or the portion thereof over time. The purpose of an index is to serve as a performance benchmark. It measures an active investment portfolio's exposure and performance to the market opportunity set by representing a particular market or a portion of it. An index also serves as an asset class proxy by representing characteristics of an asset class without the influence of active management. Each index can have its own calculation methodology and is usually expressed in terms of a change from a base value. Thus, the percentage change is more important than the actual numeric value.

Indexes are created using various aggregations of securities. For example, some market indexes are intended to represent an entire stock market of a country or region and thus may be used to track changes in that market over time. Other indexes may include only securities of a particular type, securities issued by companies of a certain level of market capitalization, securities issued by companies within a particular industry, securities issued by companies belonging to a particular classification (e.g., growth stocks or value stocks), and so forth.

Using conventional approaches, a market is frequently defined as a country. Therefore, a market index typically measures the value of the stock market or a portion thereof for a particular country (e.g., United States, Japan, France, Germany, etc.). In more recent years, a need has arisen for regional and global indexes. Traditional regions include Europe, Asia, Asia Pacific, Latin America, and North America. Under the conventional approaches, global indexes are constructed by first analyzing each country or region and then aggregating the results. For example, a large cap index will be determined for each country or region. Then, the large cap indexes will be combined to form a global index.

The conventional approach considers each country or in some cases, each region separately because investment professionals believe the relationship between securities within a country or region is significant. Particularly, that relationship is more significant than any relationship between securities located in different countries or regions having a similar market capitalization. In other words, conventional wisdom in the art teaches that securities should be analyzed according to the country in which the security trades. Further, securities from different countries should be analyzed together as a single pool only if the countries are related in some manner (e.g., the countries are from the same geographic region).

Much effort has gone into creating criteria that qualify a security for inclusion in a particular index. To be included in many indexes, a security must have at least a minimum level of liquidity. Liquidity is a measure of investability and refers to the ease with which a security may be traded. A security with poor liquidity may be difficult to purchase and/or sell. Alternatively, a security with high liquidity may be readily purchased and sold. The liquidity of a security can generally be determined by examining its past trading activity. If a security is traded infrequently and in small amounts, it likely has poor liquidity. Conversely, if a security is traded frequently and in large amounts, it likely has good liquidity. Because many indexes are used to benchmark the performance of managed portfolios, including mutual funds, securities in which money managers cannot invest, such as securities with poor liquidity, are excluded from the index.

There are many methods of identifying securities with inadequate liquidity and excluding them from indexes. However, as mentioned above, when constructing a global index, these methods analyze each country and/or region of a global index separately.

Morgan Stanley Capital International Inc. (“MSCI”), headquartered in New York, N.Y., evaluates liquidity using a security's annualized traded value ratio (ATVR). The ATVR of a security is calculated according to the following three-step process:
1. Calculate a monthly median traded value for the security. The monthly median traded value is calculated by multiplying the median daily traded value by the number of days in the month that the security was traded. The daily traded value is the number of shares traded during the day multiplied by the closing price of the security. The median daily traded value is the median of the daily traded values in a given month.
2. Calculate a monthly median traded value ratio by dividing the monthly median traded value of the security by the free-float adjusted market capitalization of the company that issued the security at the end of the month. A company's market capitalization is defined as the aggregate value of the company. A company's market capitalization is calculated by multiplying the number of the company's shares outstanding by the current price per share. Free-float value refers to the value of shares of the security available for trading on the exchange. Free-float typically excludes restricted stock and large personal holdings by company insiders because such shares are not available for trading. The free-float adjusted market capitalization of a company is the number of shares available for trading multiplied by their value.
3. Calculate ATVR by averaging the monthly median traded value ratios for the previous 12 months (or the number of months for which data is available) and multiplying the average monthly median traded value ratios by 12 (or the number of months for which data is available).

MSCI considers a security adequately liquid for inclusion in a developed market index if it has an ATVR of at least 0.20. MSCI considers a security adequately liquid for inclusion in an emerging market index if it has an ATVR of at least 0.15.

FTSE, an independent company owned by The Financial Times and the London Stock Exchange, and headquartered in London, England, evaluates the liquidity of a security using its Enhanced Liquidity Rule. First, FTSE calculates a free-float adjusted daily traded volume of the security for every day of a given month. The free-float-adjusted daily traded volume for each day is calculated by dividing the volume of the security traded on that day by the number of free-float shares of the security. The daily values are then ranked and the middle value is selected as the median for the month (i.e., a median daily trade). To be considered as having adequate liquidity for inclusion in an index, the security must satisfy the following four conditions:
1. The security must trade at least 0.05% of its free-float-adjusted shares in issue, based on the median trade in 10 of the previous 12 months;
2. The security must trade at least 0.04% of its free-float-adjusted shares in issue, based on its median daily trade per month in 8 of the previous 12 months;
3. The security must turnover at least 0.05% of its free-float-adjusted shares in issue, based on their median daily trade per month in each month since the security was initially listed; and
4. The security must have a trading record that includes at least three months of trading activity.

The Standard & Poor's/Citigroup a division of The McGraw-Hill Companies, Inc. (“S&P/Citigroup”), headquartered in New York, N.Y., considers a security has adequate liquidity for inclusion in an index if the security has an annual trading volume that is greater than $25 million measured in United States dollars (“USD”), a stock-level float adjusted market capitalization of at least $100 million USD, and a country-level float adjusted market capitalization of at least $1 billion USD.

Unfortunately, these approaches do not work equally well for all securities traded on all exchanges. Particularly, the minimum values used by S&P/Citigroup may be too large for some foreign markets. For example, an individual security in an emerging market country may have a float adjusted market capitalization greater than $100 million USD, but if the total float adjusted market capitalization for all securities in the specific emerging market country is less than $1 billion USD, the security is not included in the index. Therefore, using the S&P/Citigroup method, a minimum annual trading volume, and a minimum float adjusted market capitalization must be determined for each foreign market. This requires substantial time and effort. Further, these numerous minimum values would complicate the liquidity determination to the detriment of investors. The methods used by MSCI and FTSE require the calculation and storage of daily and/or monthly statistics. Again, these numerous statistical values complicate the liquidity determination and make understanding how an index is constructed difficult for many investors.

Therefore, a need exists for a method of determining whether a security is adequately liquid for inclusion in an index that may be applied to securities traded on the global market. In particular, a method that may be applied to all securities traded in the global market is desirable. A need also exists for a method of determining whether a security is adequately liquid for inclusion in an index that is readily understandable by investors. New, reasonably accurate methods of measuring the liquidity of a security are also desirable. The present application provides these and other advantages as will be apparent from the following detailed description and accompanying figures.

### BRIEF DESCRIPTION OF THE SEVERAL VIEWS OF THE DRAWING(S)

FIG. 1 is a flow diagram of an exemplary embodiment of a method of filtering or screening securities from a pool of global securities that do not satisfy minimum liquidity criteria.

### DETAILED DESCRIPTION OF THE INVENTION

### DEFINITION OF TERMS

Unless defined otherwise, technical and financial terms used herein have the same meaning as commonly understood by one of ordinary skill in the art to which this invention belongs. For purposes of the present invention, the following terms are defined below.

Co-listing and Cross Listing Security: a security having shares traded on more than one exchange. The exchanges may include one or more domestic exchanges, one or more foreign exchanges, and a combination thereof.

Depositary Receipt: A negotiable financial instrument issued by a bank to represent a foreign company's publicly traded securities. The depositary receipt trades on a local stock exchange. Depositary receipts make it easier to buy shares in foreign companies. When the depositary bank is in the U.S., the instruments are known as American Depositary Receipts (“ADRs”). Banks outside of the U.S. issue global depositary receipts (“GDRs”).

Domestic Exchange: with respect to a security, an exchange residing in the same country in which the company that issued the security was formed.

Dual Listing Company: two listed companies under a contractual arrangement that operate as if they were a single economic enterprise, but retain separate legal identities, tax residencies, and stock exchange listings. Dual-listed companies have a different set of shareholders, but share ownership of all business operations. Additionally, shareholders retain existing shares with economic interest in the combined assets of both companies, and shareholders of each company have equivalent dividend, capital, and voting rights on a per share basis. An example of a dual-listed companies is Unilever (UK) and Unilever NV (Netherlands).

Free-Float Adjusted Market Capitalization: Free-float adjusted market capitalization is calculated by multiplying a security's price by the number of shares readily available in the market. Instead of using all of the shares outstanding (as would be done using a full-market capitalization method), the free-float method excludes locked-in shares (such as shares in a large personal holding owned by the company itself or by a government) because such shares are not readily available for trading. The free-float method is typically considered to be a better way of calculating market capitalization because the free-float method provides a more accurate reflection of market movements. The resulting market capitalization calculated using a free-float methodology is smaller than a market capitalization calculated using the full-market capitalization method.

Foreign Exchange: with respect to a security, an exchange residing in a country other than the country in which the company that issued the security was formed.

Issue, Security, Company Relationship: an issue is stock-exchange specific. A security can have multiple issues that trade on different exchanges, while a company can have multiple security classes that are traded as different securities.

Market Capitalization: the number of securities (e.g., stock) issued by a company multiplied by their market value.

Primary Exchange: in general, a primary exchange for a security is a domestic exchange where the security is most liquid. Other factors such as inadequate liquidity on the domestic exchange, incorporation for benefit (tax, etc.), may influence the primary exchange assignment.

Primary Issue/Listing: an issue/listing of a security on its primary exchange.

Secondary Issue/Listing: an issue/listing of a security on an exchange other than its primary exchange.

Security Total Market Capitalization: the price of a security on its primary exchange multiplied by the total shares outstanding of the security. Depository receipts may be excluded from the security total market capitalization.

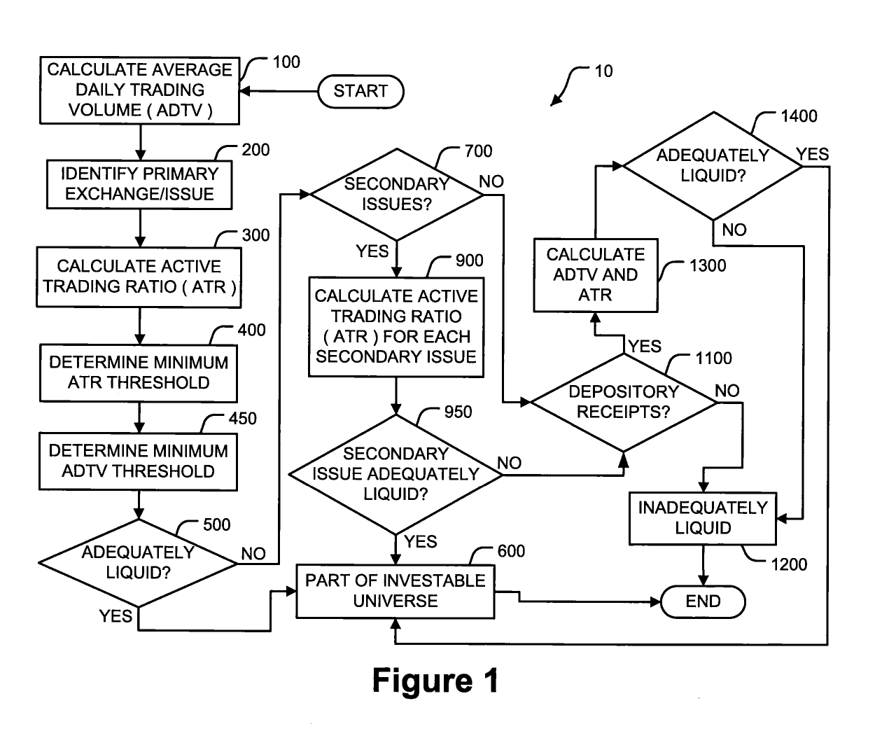

Referring to FIG. 1, aspects of the present invention include a method 10 of filtering or screening securities from a pool of global securities that do not satisfy minimum liquidity criteria. The pool of global securities may be obtained from vendors known to one of ordinary skill in the art as a source of such information. Exemplary vendors of such information include The Thomson Corporation (e.g., The Worldscope Global database) of Stamford, Conn., Telekurs Financial Information, Ltd. (e.g. Valordata feed) of Zurich, Switzerland, and the like. The information provided by the vendor(s) identifies the exchanges on which the securities are traded.

Securities issued by dual-listed companies may be treated as two separate securities. A company can issue multiple classes of securities that trade as different securities. Each class of security issued by a company may be treated as a separate security. Alternatively, the classes issued by a company may be combined and considered a single security having shares that trade at different prices depending at least in part on their class. As mentioned above, a security can have multiple issues that trade on different exchanges. A particular issue is associated with the exchange on which the issue is traded. Therefore, a portion of the securities in the pool of securities are co-listed and have issues traded on more than one exchange. As is apparent to those of ordinary skill, each issue trades at a price determined by the exchange on which the issue trades. Therefore, a single security may have shares that trade at different prices depending at least in part on the issue to which the shares belong.

In first block 100, an Average Daily Trading Volume (“ADTV”) is calculated for at least a portion of the issues of each security in the pool. If a security has only a single issue, the ADTV is calculated for that issue. Alternatively, if a security has multiple issues, the ADTV may be calculated for a portion of those issues. For example, the ADTV may be calculated for only local (domestic) issues. Alternatively, the ADTV is calculated for all of the issues of a security.

ADTV is calculated by dividing an issue's trading volume accumulated during a predetermined time period by a selected number of days including all or a portion of the predetermined time period. The numerator, the issue's accumulated trading volume, is calculated by totaling the volume of the issue traded on its exchange over the predetermined time period. The trading volume may be measured in any currency, such as United States dollars, euros, and other currencies. Any suitable amount of time may be used as the predetermined time period. For example, the predetermined time period may be about one year. In some embodiments, the denominator (i.e., the selected number of days within the predetermined time period) is equal to the number of days the exchange associated with the issue was open for trading during the predetermined time period. Alternatively, the denominator may be equal to the number of days in the predetermined time period including non-trading days or a subset thereof (e.g., the number of days in the predetermined time period excluding weekends). The ADTV may smooth abnormal trading volumes over short periods of time and measure actual transactions taking place on the exchange associated with each issue.

In block 200, a primary exchange is identified for each security in the pool. Block 200 begins by determining which exchanges are candidates for the primary exchange of a security. If a security trades on a single exchange (i.e., the security has only a single issue), the determination is simple and block 200 may simply select the exchange on which the security is traded. However, if a security is co-listed, all of the exchanges on which the issues trade or a portion thereof may be considered. In the case of such co-listed companies, their primary exchange is typically a domestic exchange. By way of non-limiting example, block 200 may consider only domestic exchanges on which issues of the security are traded as candidate exchanges for the purpose of identifying a domestic exchange as the primary exchange. Alternatively, block 200 may consider all exchanges on which issues of the security are traded. If the ADTV was calculated for only a portion of the issues of a security, the candidate exchanges may include the exchanges on which those issues are traded.

Then, block 200 compares the ADTV values of each of the issues of a security associated with a candidate exchange and selects the exchange associated with the issue having the largest ADTV value as the primary exchange. For example, block 200 may compare the ADTV values of all or a portion of the local issues (i.e., issues traded on a domestic exchange) of a security and select the domestic exchange associated with the local issue having the largest ADTV value as the primary exchange. The issue traded on the primary exchange is the primary issue of the security. The ADTV value of a security is the ADTV value of its primary issue.

Then, in block 300, the Active Trading Ratio (“ATR”) is calculated for each security in the pool. ATR is calculated by dividing the number of active trading days for the security's primary issue on the primary exchange by a selected number of days including all or a portion of a predetermined time period. The numerator, the number of active trading days, is calculated by totaling the number of days at least one share of the primary issue of the security was traded on its primary exchange within the predetermined time period. Any suitable amount of time may be used as the predetermined time period. For example, the predetermined time period may be about one year. The same predetermined time period may be used to calculate both the ADTV and the ATR or different time periods may be used. In some embodiments, the denominator (i.e., the selected number of days within the predetermined time period) is equal to the number of days the security's primary exchange was open for trading during the predetermined time period. Alternatively, the denominator may be equal to the number of days in the predetermined time period including non-trading days or a subset thereof (e.g., the number of days in the predetermined time period excluding weekends).

As is apparent to those of ordinary skill in the art, the ATR of each security will be a value from zero to one. The ATR provides further insight into the liquidity of a security. For example, the ATR may help determine whether a security's ADTV has been distorted by a few large transactions (e.g., a security with a large ADTV and a small ATR was traded infrequently but in large volumes) and therefore, may not be adequately liquid for inclusion in the index.

The minimum liquidity criteria mentioned above may include both a minimum Active Trading Ratio threshold (“minimum ATR threshold”) and a minimum Average Daily Trading Volume threshold (“minimum ADTV threshold”). In block 400, the minimum ATR threshold is selected. The minimum ATR threshold may be a predetermined value (e.g., 0.3, 0.45, 0.55, 0.65, 0.7, etc.) that identifies a portion of the days the primary exchange of the security was open for trading on which the primary issue of the security must have been traded. For example, the minimum ATR threshold may be approximately 0.5, which corresponds to the security's primary issue having been traded (e.g., at least one share was traded) on at least half of the days the primary exchange of the security was open for trading. Alternatively, the minimum ATR threshold may range from approximately 0.3 to approximately 0.7.

The predetermined value used for the minimum ATR threshold may be determined empirically from an analysis of the ATR values of a pool of securities. For example, the minimum ATR threshold may be determined by selecting an initial value (e.g., 0.3) and modifying the minimum ATR threshold until ATR values of securities traded infrequently and in large blocks are below the minimum ATR threshold. Any method known by those of ordinary skill in the art may be used to identify securities traded infrequently and in large blocks. Empirical determination of the minimum ATR threshold may also include identifying securities that should be found to be adequately liquid by the method 10. These securities may be used to determine whether the minimum ATR threshold is too high and thus, is determining that adequately liquid securities are inadequate. Again, the minimum ATR threshold may be modified until ATR values of a satisfactory number of securities traded infrequently and in large blocks are below the minimum ATR threshold and a satisfactory number of adequately liquid securities are above the minimum ATR threshold. Any method known to those of ordinary skill in the art may be used to identify securities that should be found to be adequately liquid by the method 10.

Next in block 450, the minimum ADTV threshold is determined. As mentioned above, the ADTV value of a security is the ADTV of the primary issue of the security. The minimum ADTV threshold may be calculated as a function of the ADTV values of the securities in the pool. For example, the minimum ADTV threshold may be set to a median ADTV value of the securities in the pool. For 2007, the median ADTV is approximately $150,000 USD. In some embodiments, the minimum ADTV threshold is a median ADTV value of a portion of the securities in the pool that excludes some securities. Non-limiting examples of securities that may be excluded include securities owned by a government, securities that are highly regulated by a government, and the like. Such securities (e.g., public utilities owned by some foreign governments) may be excluded because they have an ‘insulated’ price that is often slow-moving or even static.

Securities having an ADTV below the median ADTV may have been issued by companies that combined compose the bottom 5% of a sum of the market capitalizations of all of the securities, including both investable and non-investable securities, in the pool. In other words, while using the median ADTV as the minimum the median ADTV threshold removes approximately half of the securities from the pool of securities, using the median ADTV as the minimum the median ADTV threshold removes only about 5% of the total market capitalization. Examination of the ADTV values of securities having an ADTV below the median ADTV has shown that when such securities are arranged in descending order according to security total market capitalizations, the ordering of the securities approximates an ordering of the same securities according to descending order of ADTV. In essence, ADTV may help identify securities that (when traded on) may expose investors to extreme price pressure and for this reason, are considered non-investable.

Alternatively, the minimum ADTV threshold may be set to other statistics calculated as a function of the ADTV values of the securities in the pool, such as a mean, a median, a selected percentile, and the like. Further, constants may be added to such minimum ADTV thresholds. Additionally, the minimum ADTV threshold may be scaled. For example, the minimum ADTV threshold may be set equal to the median ADTV multiplied by a scale factor (e.g., 1.01, 0.98, and the like). It may be desirable to use a consistent formula or method to calculate the minimum ADTV threshold each time the index is reconstituted. In this manner, manual and/or inconsistent adjustment of the minimum ADTV threshold may be avoided. However, if an unusual or onetime event occurs, manual adjustment of the calculated minimum ADTV threshold may be necessary.

Then, decision block 500 uses the minimum ADTV threshold and minimum ATR threshold to determine whether the securities in the pool are adequately liquid. Securities determined to be adequately liquid by decision block 500 are added to the investable universe in block 600. In other words, these securities are not screened from the pool of securities, which at the completion of the method 10 includes the investable universe of securities. Securities determined to be inadequately liquid by decision block 500 advance to block 700.

Decision block 500 determines whether the securities in the pool are adequately liquid by comparing the ADTV and ATR of each security in the pool to the minimum ADTV threshold and minimum ATR threshold, respectively. If the ADTV of a security is greater than or equal to the minimum ADTV threshold and the ATR of the security is greater than or equal to the minimum ATR threshold, the security is identified as adequately liquid by block 500. However, if the ADTV of the security is less than the minimum ADTV threshold and/or the ATR of the security is less than the minimum ATR threshold, the security may not be adequately liquid.

If initially, in block 200, only a portion of the exchanges on which issues of a security are traded (e.g., only domestic exchanges) were considered in determining the primary exchange of the security, it may be possible that another issue of the security is more liquid. In other words, if the security has both domestic and foreign listings, and block 200 considered only the domestic listing(s), the method 10 may replace the primary exchange with a different exchange (e.g., a foreign exchange). In such cases, a secondary issue may be identified as the primary listing and its exchange may be identified as the primary exchange for the inadequately liquid security.

Because method 10 determines the liquidity of a security with respect to its primary exchange, the selection of that exchange affects the results of the method. If initially, in block 200, a domestic exchange was identified as the primary exchange, the primary exchange may be replaced with a foreign exchange on which an issue of the security is traded. While trading activity at the domestic exchange may fail to satisfy the minimum liquidity criteria and thereby render a security inadequately liquid, trading activity with respect to a foreign exchange may satisfy the liquidity criteria, thereby rendering the security adequately liquid.

Decision block 700 determines whether a security found to be inadequately liquid by decision block 500 has one or more secondary issues. An inadequately liquid security has secondary issues if the security has issues listed on exchanges not considered previously by the method 10 (e.g., exchanges not considered by block 200). For example, if block 200 considered only domestic exchanges, and the security has issues traded on one or more foreign exchanges, decision block 700 determines the security has a secondary issue and the method 10 advances to block 900. However, not all inadequately liquid securities have issues listed on an exchange not considered by block 200. In such cases, decision block 700 determines no secondary issues exist and the method 10 advances to block 1100. In essence, decision block 700 routes securities that have a secondary issue to block 900 and securities that do not have a secondary issue to block 1100.

For each inadequately liquid security having a secondary issue, block 900 calculates an ATR for each secondary issue. If in block 100, the ADTV was calculated for only a portion of the issues of a security, block 100 may not have calculated an ADTV for one or more of the secondary issues of an inadequately liquid security. Block 900 calculates the ADTV for each secondary issue of an inadequately liquid security for which block 100 did not calculate the ADTV.

Then, for each inadequately liquid security having a secondary issue, decision block 950 determines whether the most liquid secondary issue is adequately liquid for inclusion in the investable universe. Specifically, block 950 determines whether any of the issues have an ADTV value greater than or equal to the minimum ADTV threshold and an ATR value greater than or equal to the minimum ATR threshold. For each inadequately liquid security having a secondary issue that satisfies these criteria, the method 10 advances to block 600 and adds the security to the investable universe.

At this point, the underlying information (i.e., the ADTV values) used to calculate the minimum ADTV threshold has changed because a different issue (i.e., a secondary issue) has been used to calculate the ADTV value for at least a portion of the securities in the pool of securities. Optionally, the method 10 may decide to recalculate the minimum ADTV threshold. However, recalculating the minimum ADTV threshold is not necessary. If the minimum ADTV threshold is recalculated by the method 10, any securities previously determined to be adequately liquid by the method 10 may be determined to be inadequately liquid if the ADTV of the security is less than the recalculated minimum ADTV threshold. Optionally, each of these inadequately liquid securities may be routed to block 700 (if the security has not been evaluated with respect to a secondary issue), to block 1100 (if the security has not been evaluated with respect to a depository receipts), or to block 1200 (if the security has been evaluated with respect to both a secondary issue and depository receipts).

Decision block 1100 determines whether a security found to be inadequately liquid by decision block 500 is traded as depository receipts. Securities not traded as depository receipts advance to block 1200, which determines they are inadequately liquid for inclusion in the investable universe. Securities that are traded as depository receipts proceed to block 1300.

Like securities, depository receipts may trade on multiple exchanges. Therefore, block 1300 calculates ADTV and ATR values for each exchange on which depository receipts are traded. Then, for each inadequately liquid security traded as depository receipts, decision block 1400 determines whether the most liquid depository receipts are adequately liquid for inclusion in the investable universe. Specifically, block 1400 determines whether any of the depository receipts have an ADTV value greater than or equal to the minimum ADTV threshold and an ATR value greater than or equal to the minimum ATR threshold. For each inadequately liquid security traded as depository receipts that satisfy these criteria, the method 10 advances to block 600 and adds the security to the investable universe. Securities traded as depository receipts failing to satisfy these criteria advance to block 1200, which determines they are inadequately liquid for inclusion in the investable universe.

The method 10 then terminates with respect to securities determined to be inadequately liquid for inclusion in the investable universe in block 1200 and securities added to the investable universe in block 600.

At this point, the underlying information (i.e., the ADTV values) used to calculate the minimum ADTV threshold has changed because depository receipts have been used to calculate the ADTV of at least a portion of the securities in the pool of securities. Optionally, the method 10 may decide to recalculate the minimum ADTV threshold. However, recalculating the minimum ADTV threshold is not necessary. If the minimum ADTV threshold is recalculated by the method 10, any securities previously determined to be adequately liquid by the method 10 may be determined to be inadequately liquid if the ADTV of the security is less than the recalculated minimum ADTV threshold. Optionally, each of these inadequately liquid securities may be routed to block 700 (if the security has not been evaluated with respect to a secondary issue), to block 1100 (if the security has not been evaluated with respect to a depository receipts), or to block 1200 (if the security has been evaluated with respect to both a secondary issue and depository receipts).

When the method 10 terminates, securities determined to be adequately liquid in block 600 may be used to construct one or more indexes. Any depository receipts determined to be adequately liquid in block 600 may be considered the primary issue of the security. Further, if a security was found to be adequately liquid even though its primary domestic issue was inadequately liquid because one of its secondary issues was determined to be adequately liquid, the adequately liquid secondary issue is considered to be the primary issue of the security.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method of identifying securities in a pool of global securities that are adequately liquid for inclusion in a global index or for foreign investment, each security comprising one or more issues, the method comprising:
for each security in the pool of global securities,
selecting a portion of the one or more issues of the security;
calculating an Average Daily Trading Volume for each issue in the portion of the one or more issues,
selecting the issue in the portion of the one or more issues having the largest Average Daily Trading Volume as the primary issue, and
calculating an Active Trading Ratio for the primary issue;
determining a minimum Average Daily Trading Volume threshold;
selecting a minimum Active Trading Ratio threshold; and
for each security in the pool of global securities, if the Average Daily Trading Volume of the primary issue is greater than the minimum Average Daily Trading Volume threshold and the Active Trading Ratio of the primary issue is greater than the minimum Active Trading Ratio threshold, identifying the security as adequately liquid.

2. The method of claim 1, wherein the primary issue is traded on a primary exchange, and for each security in the pool of global securities,
the primary exchange was open for trading a number of trading days during a predetermined time period,
a volume of the primary issue of the security was traded on the primary exchange during the predetermined time period, and
the Average Daily Trading Volume is calculated as a function of the volume of the primary issue of the security traded on the primary exchange during the predetermined time period, and the number of trading days of the primary exchange of the security.

3. The method of claim 1, wherein the primary issue is traded on a primary exchange, and for each security in the pool of global securities,
the primary exchange was open for trading a number of trading days during a predetermined time period,
the number of trading days comprises a number of active days,
a volume of the primary issue of the security was traded on the primary exchange on each of the active days, and
the Active Trading Ratio is calculated as a function of the number of active days on which the volume of the primary issue of the security was traded on its primary exchange and the number of trading days of the primary exchange of the security.

4. The method of claim 1, wherein determining the minimum Average Daily Trading Volume threshold comprises determining a median of the Average Daily Trading Volume of the primary issues of at least a portion of the securities in the pool of securities.

5. The method of claim 4, wherein the minimum Average Daily Trading Volume threshold comprises the median of the Average Daily Trading Volume of the primary issues of at least the portion of the securities in the pool of securities.

6. The method of claim 1, wherein the minimum Active Trading Ratio threshold is within the range of approximately 0.3 to approximately 0.7.

7. The method of claim 1, wherein the minimum Active Trading Ratio threshold is 0.5.

8. The method of claim 1, wherein selecting the minimum Active Trading Ratio threshold comprises:
setting the minimum Active Trading Ratio threshold equal to a predetermined value;
identifying a plurality of securities considered inadequately liquid, each security in the plurality of securities considered inadequately liquid comprising one or more issues;
for each security in the plurality of securities considered inadequately liquid,
calculating an Average Daily Trading Volume for each issue of the one or more issues,
selecting the issue of the one or more issues having the largest Average Daily Trading Volume as the primary issue,
calculating an Active Trading Ratio for the primary issue, and
if the Active Trading Ratio of the primary issue is greater than the minimum Active Trading Ratio threshold, identifying the security as adequately liquid;
increasing the minimum Active Trading Ratio threshold to reduce the number of the securities in the plurality of securities considered inadequately liquid that were identified as adequately liquid.

9. The method of claim 1, wherein selecting the minimum Active Trading Ratio threshold comprises:
setting the minimum Active Trading Ratio threshold equal to a predetermined value;
identifying a plurality of securities considered to be minimally adequately liquid, each security in the plurality of securities considered minimally adequately liquid comprising one or more issues;
for each security in the plurality of securities considered minimally adequately liquid,
calculating an Average Daily Trading Volume for each issue of the one or more issues,
selecting the issue of the one or more issues having the largest Average Daily Trading Volume as the primary issue,
calculating an Active Trading Ratio for the primary issue, and
if the Active Trading Ratio of the primary issue is less than the minimum Active Trading Ratio threshold, identifying the security as inadequately liquid;
reducing the minimum Active Trading Ratio threshold to increase the number of the securities in the plurality of securities considered minimally adequately liquid that were identified as inadequately liquid.

10. The method of claim 1, wherein the one or more issues of a portion of the securities in the pool of global securities comprise one or more local issues and one or more foreign issues, and for each security in the portion of the pool of global securities, the selected portion of the one or more issues of the security comprises the one or more local issues, the method further comprising:
for each security in the pool of global securities, calculating an Average Daily Trading Volume for each issue not in the selected portion of the one or more issues; and
for each security in the portion of the pool of global securities that was not identified as adequately liquid,
calculating an Active Trading Ratio for each of the one or more foreign issues, and
if the Average Daily Trading Volume of at least one of the one or more foreign issues is greater than the minimum Average Daily Trading Volume threshold and the Active Trading Ratio of at least one of the one or more foreign issues is greater than the minimum Active Trading Ratio threshold, identifying the security as adequately liquid.

11. The method of claim 1, wherein the one or more issues of a portion of the securities in the pool of global securities comprise one or more local issues and one or more foreign issues, and for each security in the portion of the pool of global securities, the selected portion of the one or more issues of the security comprises the one or more local issues, the method further comprising:
for each security in the portion of the pool of global securities, calculating an Average Daily Trading Volume for each of the one or more foreign issues; and
for each security in the portion of the pool of global securities that was not identified as adequately liquid,
calculating an Active Trading Ratio for each of the one or more foreign issues, and
if the Average Daily Trading Volume of at least one of the one or more foreign issues is greater than the minimum Average Daily Trading Volume threshold and the Active Trading Ratio of at least one of the one or more foreign issues is greater than the minimum Active Trading Ratio threshold, identifying the security as adequately liquid.

12. The method of claim 1, wherein a portion of the securities in the pool of global securities are traded as depository receipts on one or more exchanges, the method further comprising:
for each security in the portion of the pool of global securities traded as depository receipts and not identified as adequately liquid,
for each exchange of the one or more exchanges on which depository receipts are traded, calculating an Active Trading Ratio and an Average Daily Trading Volume for depository receipts traded on the exchange, and
if the Average Daily Trading Volume of the depository receipts traded on at least one of the one or more exchanges is greater than the minimum Average Daily Trading Volume threshold and the Active Trading Ratio of the depository receipts traded on at least one of the one or more exchanges is greater than the minimum Active Trading Ratio threshold, identifying the security as adequately liquid.

13. A method of determining minimum liquidity criteria for inclusion in a global index, the method comprising:
identifying a pool of global securities, each security comprising one or more issues each associated with an exchange, each exchange having a number of trading days during a predetermined time period, a volume of each issue having been traded on the exchange associated therewith during the predetermined time period, the number of trading days of each exchange comprising a number of active days, a portion of the volume of each issue having been traded on each of the active days of the exchange associated with the issue, the one or more issues comprising a primary issue traded on a primary exchange;
for each security in the pool of global securities,
calculating an Average Daily Trading Volume for each of the one or more issues as a function the volume of the issue traded on its associated exchange during the predetermined time period, and the number of trading days of the exchange associated with the issue during the predetermined time period;
identifying the primary issue from among the one or more issues of the security, and
calculating a minimum Average Daily Trading Volume threshold as a function of the Average Daily Trading Volume of the primary issue of a portion of the securities in the pool of securities; and
determining a minimum Active Trading Ratio threshold,
wherein each the primary issue of security has an Active Trading Ratio, the minimum liquidity criteria comprises the minimum Average Daily Trading Volume threshold and the minimum Active Trading Ratio threshold, and a security satisfies the minimum liquidity criteria if the Average Daily Trading Volume of the primary issue of the security is greater than the minimum Average Daily Trading Volume threshold and the Active Trading Ratio of the primary issue of the security is greater than the minimum Active Trading Ratio threshold.

14. The method of claim 13, wherein for each security in the pool of global securities, the Active Trading Ratio is calculated as a function of the number of active days on which the primary issue was traded on its primary exchange during the predetermined time period and the number of trading days of the primary exchange during the predetermined time period.

15. The method of claim 13, wherein for each security in the pool of global securities, the Active Trading Ratio is calculated by dividing the number of active days on which the primary issue was traded on the primary exchange during the predetermined time period by the number of trading days of the primary exchange during the predetermined time period.

16. The method of claim 13, wherein the Average Daily Trading Volume is calculated for each of the one or more issues by dividing the volume of the issue traded on the exchange associated with the issue during the predetermined time period by the number of trading days of the exchange associated with the issue during the predetermined time period.

17. The method of claim 13, wherein the minimum Average Daily Trading Volume threshold is a median Average Daily Trading Volume of the primary issues of a portion of the securities in the pool of securities.

18. The method of claim 13, wherein the minimum Active Trading Ratio threshold ranges from approximately 0.3 to approximately 0.7.

19. An index constructed from a plurality of securities, the index comprising a portion of the plurality of securities, each security in the portion comprising a primary issue having an Average Daily Trading Volume greater than a minimum Average Daily Trading Volume threshold, and an Active Trading Ratio greater than a minimum Active Trading Ratio threshold.

20. The index of claim 19, wherein the minimum Active Trading Ratio threshold is 0.5.

21. The index of claim 19, wherein each of the securities in the plurality of securities comprises a primary issue and the minimum Average Daily Trading Volume threshold is a median Average Daily Trading Volume of the primary issues of the securities in the plurality of securities.

22. A method of constructing an index, the method comprising:
selecting a pool of global securities, each security in the pool comprising one or more issues;
for each security in the pool of global securities,
selecting a portion of the one or more issues of the security;
calculating an Average Daily Trading Volume for each issue in the portion of the one or more issues,
selecting the issue in the portion of the one or more issues having the largest Average Daily Trading Volume as the primary issue, and
calculating an Active Trading Ratio for the primary issue;
determining a minimum Average Daily Trading Volume threshold;
selecting a minimum Active Trading Ratio threshold; and
for each security in the pool of global securities, if the Average Daily Trading Volume of the primary issue is greater than the minimum Average Daily Trading Volume threshold and the Active Trading Ratio of the primary issue is greater than the minimum Active Trading Ratio threshold, adding the security to the index.

23. The method of claim 22, further comprising:
for each security in a portion of the securities in the pool of global securities not added to the index,
replacing the primary issue with an issue that was not included in the selected portion of the one or more issues of the security, the replacement primary issue having an Average Daily Trading Volume of greater than the minimum Average Daily Trading Volume threshold and an Active Trading Ratio greater than the minimum Active Trading Ratio threshold; and
adding the security to the index

24. The method of claim 22, further comprising:
for each security in a portion of the securities in the pool of global securities not added to the index,
replacing the primary issue with depository receipts, the replacement primary issue having an Average Daily Trading Volume of greater than the minimum Average Daily Trading Volume threshold and an Active Trading Ratio greater than the minimum Active Trading Ratio threshold; and
adding the security to the index
